(19) United States
(12) Patent Application Publication
(10) Pub. No.: US 2016/0063632 A1
(43) Pub. Date: Mar. 3, 2016

(54) METHOD AND APPARATUS FOR CALCULATING AN OPTIMAL RETIREMENT PLAN BASED ON INCOME NEEDS, INCOME SOURCES AND FEDERAL INCOME TAX IMPACTS

(71) Applicants: Mark Alan Folk, Powell, OH (US); Joshua Allan Pick, Lewis Center, OH (US)

(72) Inventors: Mark Alan Folk, Powell, OH (US); Joshua Allan Pick, Lewis Center, OH (US)

(21) Appl. No.: 14/840,429

(22) Filed: Aug. 31, 2015

Related U.S. Application Data
(60) Provisional application No. 62/043,468, filed on Aug. 29, 2014.

(51) Int. Cl. G06Q 40/06

(52) U.S. Cl. CPC G06Q 40/06

(57) ABSTRACT

Methods and apparatuses for calculating an optimal retirement plan based on income needs, incomes sources and federal income tax impacts for individuals and married couples is disclosed. Financial information of the user(s) is used to create a user profile(s) which comprises retirement income requirements, available income sources and investment risk tolerance of the user. The user profile is used to calculate a suggested strategy which balances the income requirements of the user impacted by taxes to the available income sources and accounting for investment risks of the user and a set of all possible life and death variables. A life plan is created using the suggested strategy, the set of all possible life and death variables and the user profile, and presented as output to show the optimal retirement plan.

### TECHNICAL FIELD

Embodiments described herein relate generally to retirement planning, and more particularly, to a method and apparatus for calculating an optimal retirement plan based on income needs, incomes sources and federal income tax impacts for individuals and married couples.

### BACKGROUND

Some known retirement planning calculators typically apply a “break-even” analysis to make a decision for when to elect Social Security for a user. Some other known retirement planning calculators can analyze the impact of different Social Security benefit elections. Such known calculators, however, typically analyze the elections on a scenario by scenario basis, in which a user inputs a set of election ages and the tool calculates the result of those election ages providing a landscape of the effect of various election decisions. As such, these retirement planning calculators still require the client to run through a number of scenarios, which can remain confusing to some, in which to eventually settle on which Social Security election decisions should be made for retirement purposes. Additionally, as only one source of income is considered, such retirement planning calculators both fail to take into account the tax implications of such income when combined with other sources, and fail to answer to the question of “what do I (we) need to do now to make sure I (we) do not outlive our retirement income?”

### SUMMARY

It is against the above background that the inventor recognized a need for a method and apparatus for calculating an optimal retirement plan based on income needs, income sources and federal income tax impacts for individuals and married couples.

For example, in one embodiment, disclosed is a non-transitory processor-readable medium storing code representing instructions to be executed by a processor for retirement planning. The instructions which when executed cause the processor to: receive as input financial information which comprises desired retirement age, retirement income requirements, available income sources and investment risk tolerance of a user, and create a user profile from the financial information received. The instructions also cause the processor to calculate, using the user profile, a suggested strategy which balances the income requirement impacted by taxes to the available income sources and accounting for the investment risk tolerance of the user, and calculate, using the user profile, a set of all possible life and death variables. The instruction further cause the processor to create a life plan using the set of all possible life and death variables and user profile, and present as output on a display the life plan which comprises an optimal retirement plan based on inputted desired retirement age, income requirements, inputted available incomes sources, and income tax impacts to the user.

In another embodiment, disclosed is an optimal retirement plan calculating apparatus for a user, which comprises a display, a processor, and memory storing code which when executed by the processor causes the processor to: receive as input financial information which comprises desired retirement age, retirement income requirements, available income sources and investment risk tolerance of a user; create a user profile from the financial information received; calculate, using the user profile, a suggested strategy which balances the income requirement impacted by taxes to the available income sources and accounting for the investment risk tolerance of the user; calculate, using the user profile, a set of all possible life and death variables; create a life plan using the set of all possible life and death variables and user profile; and present as output on the display the life plan which comprises an optimal retirement plan based on inputted desired retirement age, income requirements, inputted available incomes sources, and income tax impacts to the user.

In still another embodiment, a retirement planning system for a user is disclosed that can comprise a host device with a processor and memory storing code which when executed causes the processor to implement an input module, a profile agent module, a grid analyst module, a multi-variables calculation module, a full-life planner module and a tax builder module. The host device receives via the input module one or more input values related to a desired retirement age, income needs and incomes sources of the user, and creates automatically via the profile agent module a user profile based on the one or more input values received. The host device also selects automatically via the grid analyst module applicable life and death variables from a life and death variables database based on the user profile created, and determines automatically via the multi-variables calculation module result data based on the user profile created and the application life and death variables selected. The result data can comprise values for a current total retirement income and a maximized total retirement income, and information regarding benefit election option and tax filing status selected which resulted in the maximized total retirement income determined by the multi-variable calculation module. The host device determines automatically via the full life planner module, which runs a tax loop process, a life plan which comprises a breakdown of yearly Social Security income if filed at the inputted desired retirement age versus according to an age, type of SS benefit election, and tax filing status as provided in the resulting data, wherein in the tax loop process, the full life planner module automatically requests the tax builder module perform and provide tax calculations and/or generate and provide completed tax forms based in the resulting data outputted from the multi-variables calculation module as well as the user profile. The host device provides the life plan as output from the full life planner module and the tax builder module that results from the tax loop process.

In still another embodiment disclosed is a computer-implemented retirement planning method that creates a life plan which shows and explains an optimal retirement plan based on inputted desired retirement age, inputted income needs, inputted incomes sources, and income tax impacts to a user. The method can comprise the process steps of: executing via a processor code which implements on a host device an input module, a profile agent module, a grid analyst module, a multi-variables calculation module, a full-life planner module and a tax builder module; receiving via the input module one or more input values related to the desired retirement age, income needs and the incomes sources of the user; creating automatically via the profile agent module a user profile based on the one or more input values received; selecting automatically via the grid analyst module applicable life and death variables from a life and death variables database based on the user profile created; determining automatically via the multi-variables calculation module result data based on the user profile created and the application life and death variables selected, the result data providing values for a current total retirement income and a maximized total retirement income, and information regarding benefit election option and tax filing status selected which resulted in the maximized total retirement income determined by the multi-variable calculation module; determining automatically via the full life planner module running a tax loop process, a life plan which comprises a breakdown of yearly Social Security income if filed at the inputted desired retirement age(s) versus according to the age(s), type of SS benefit election, and tax filing status as provided in the resulting data, wherein during the tax loop process, the full life planner module automatically requests the tax builder module perform and provide tax calculations and/or generate and provide completed tax forms based in the resulting data outputted from the multi-variables calculation module as well as the user profile; and providing the life plan as output from the full life planner module and the tax builder module resulting from the tax loop process.

The above described embodiments and further features and advantages of the invention will be apparent from the following detailed description of the various embodiments that are illustrated schematically in the accompanying drawings.

### BRIEF DESCRIPTION OF THE DRAWINGS

FIG. 1 is a schematic diagram that illustrates communication devices in communication with a host device via a network, according to an embodiment.

FIG. 2 is a schematic diagram of a host device configured to perform a life plan which shows and explains an optimal retirement plan to a user, according to an embodiment.

FIG. 3 illustrates inputs and outputs of projected benefit of maximized plan for a married couple, according to an embodiment.

FIGS. 4A, 4B and 4C illustrate output of a life plan to maximize retirement income which provides a suggested Social Security election strategy, impact of following versus not following the election strategy, and resulting retirement income flow if following the life plan to maximum income for a married couple, according to an embodiment.

FIG. 5 is a flow chart illustrating a method of creating a life plan to maximize retirement income, according to an embodiment.

### DETAILED DESCRIPTION

Before explaining the disclosed embodiments of the present invention in detail it is to be understood that the invention is not limited in its applications to the details of the particular arrangements shown since the invention is capable of other embodiments.

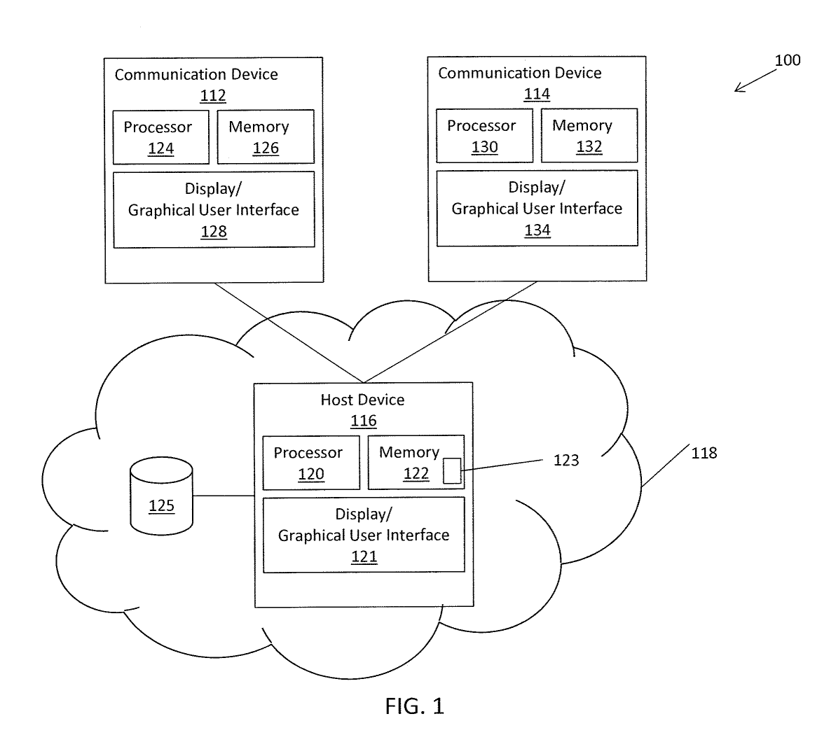

FIG. 1 is a schematic diagram that illustrates a retirement planning system 100 which comprises communication devices 112, 114 in communication with a host device 116, via a network 118, according to an embodiment. Specifically, the communication devices 112, 114 are configured to be operatively coupled to and communicate with the host device 116 via the network 118. The network 118 can be any type of network (e.g., a local area network (LAN), a wide area network (WAN), a virtual network, a telecommunications network, etc.) implemented as a wired network and/or wireless network. In some embodiments, for example, the communication devices 112, 114 can be personal computers operatively connected to the host device 116 via an Internet service provider (ISP) and the Internet (e.g., network 118). Although only the communication devices 112, 114 are shown in FIG. 1, the host device 116 can be configured to be operatively coupled to and communicate with more than two communication devices via the network 118.

The host device 116 can be any type of device configured to send data over the network 118 to and/or receive data from one or more of the communication devices (e.g., the communication devices 112, 114). In some embodiments, the host device 116 can be configured to function as, for example, a server device (e.g., a web server device), a storage device, a network management device, a data repository, and/or the like.

As shown in FIG. 1, the host device 116 includes a processor 120, a memory 122, and optionally, a display/graphical user interface 121. The processor 120 of the host device 116 can be any suitable processing device configured to run and/or execute all or some of the various features of the retirement planning system discussed herein. For example, the processor 120 can be configured to execute various modules, processes and/or methods of the retirement planning system 100 in response to receiving a signal from one of the communication devices 112, 114, as described in further detail herein. More specifically, as described in further detail herein, the processor 120 can be configured to execute modules, functions and/or processes to provide a user (e.g., an individual and/or spouse if a married couple) of one of the communication devices 112, 114 with a life plan resulting from the analysis performed by the retirement planning system 100. In some embodiments, the processor 120 can be a general purpose processor, a Field Programmable Gate Array (FPGA), an Application Specific Integrated Circuit (ASIC), a Digital Signal Processor (DSP), and/or the like.

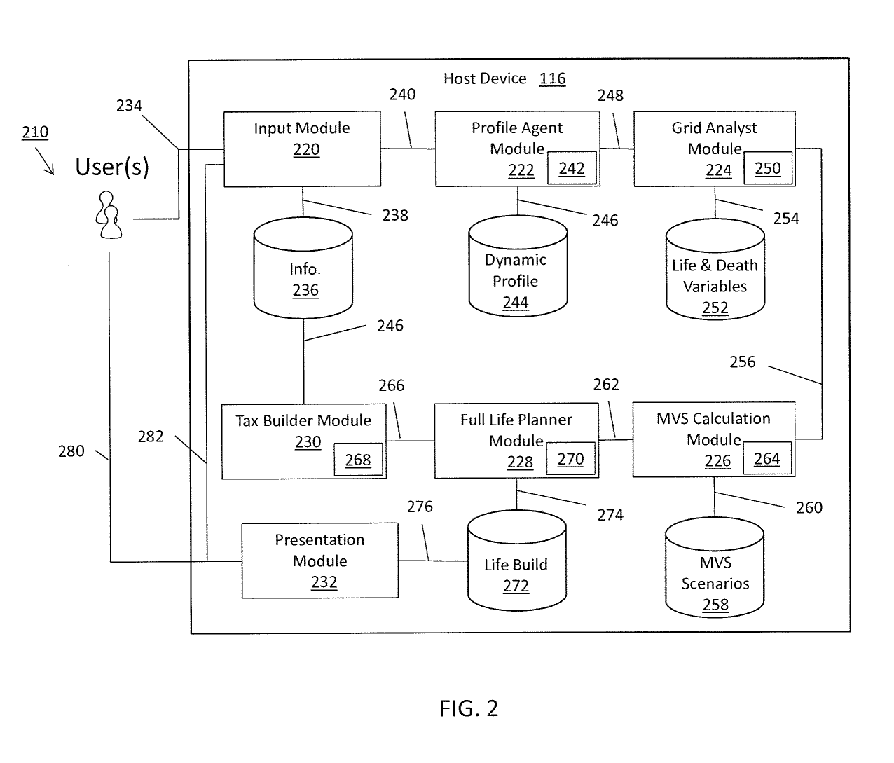

The memory 122 can be, for example, a random access memory (RAM), a memory buffer, a hard drive, a database, an erasable programmable read-only memory (EPROM), an electrically erasable read-only memory (EEPROM), a read-only memory (ROM) and/or so forth. In some embodiments, as described in detail with respect to FIGS. 2, 5 and 6, the memory 122, embodied as a non-transitory processor-readable medium, can store program instructions or program code 123 to cause the processor 120 to execute modules, processes and/or functions associated with the retirement planning system when read and executed by the processor 120. In some embodiments, the non-transitory processor-readable medium stores program code 123 representing instructions to cause a processor to receive, from a user(s), e.g. from an individual or from a married couple, an input of at least one value associated with financial information of the user(s). In some embodiments, the at least one value associated with financial information of the user(s) can include at least one of birth year/birth date, age, anticipated life expectancy, monthly expected Social Security (SS) benefit at full retirement each, SS benefit Cost of Living Adjustment (COLA), anticipated monthly pension and/or annuity, anticipated monthly pension COLA and/or annuity COLA, total current savings, anticipated Rate of Return (ROR) in retirement, desired retirement age, total desired net monthly retirement income, and anticipated inflation rate. For example, the code 123 can represent instructions to cause the processor to calculate, using the at least one value, a user profile for each inputting user. The code 123 can represent instructions to cause the processor to calculate, using the user profile(s), a suggested strategy to balance tax impacted income requirements of the user(s) to available income sources taking into account an appetite for investment risks of the user(s) as reflected by an inputted or default anticipated ROR in retirement. The code 123 can represent instructions to cause the processor to calculate, using the user profile, a set of all possible life and death variables and uses the set of all possible life and death variables of the user(s) in a multi-variant scenarios algorithm to create a life plan. The code 123 further can represent instructions to cause the processor to present the life plan, which shows and explains an optimal retirement plan based on inputted income needs, inputted incomes sources and federal income tax impacts, to the user(s).

In some embodiments, the memory 122 of the host device 116 can act as a data repository. In such embodiments, the data associated with the retirement planning system modules, functions and/or processes can be stored in the memory 122 of the host device 116. When a user (e.g., an individual, a married couple, a financial advisor, etc.) wishes to view data associated with a specific client (i.e., an individual, married couple, etc.) via, for example, one of the communication devices 112, 114, the host device 116 can send the data to the communication device 112 or 114 in response to receiving a signal requesting such data from the requesting communication device.

Further, in some embodiments, the memory 122 of the host device 116 can store account information associated with users authorized to access the data stored in the memory 122. Each user can be authorized to access certain or all portions of data stored in the memory 122. In such embodiments, for example, the host device 116 can store, within the memory 122, a username and password associated with a user or any other method of authentication, extent of authority of the user (e.g., access rights), a life plan associated with the user, and/or the like. Alternatively, such information can be stored in a database 125 within or operatively coupled to the host device 116 and/or network 118 (e.g., in the Cloud). It is to be appreciated that authentication is a process in which credentials provided are compared to those on file in a database of authorized users' information on a local operating system or within an authentication server. If the credentials match, the process is completed and the user is granted authorization for access.

Each of the communication devices 112, 114 can be, for example, a computing entity (e.g., a personal computing device such as a desktop computer, a laptop computer, tablet computer, etc.), a mobile phone, a personal digital assistant (PDA), and/or other types of wireless type handheld devices. Although not shown in FIG. 1, in some embodiments, each of the communication devices 112, 114 can include one or more network interface devices (e.g., a network interface card) configured to connect the communication devices 112, 114 to the network 118. In some embodiments, the communication devices 112, 114 can be referred to as client devices.

As shown in FIG. 1, the communication device 112 has a processor 124, a memory 126, and a display 128. The memory 126 can be, for example, a random access memory (RAM), a memory buffer, a hard drive, and/or so forth. The display 128 can be any suitable display, such as, for example, a liquid crystal display (LCD), a cathode ray tube display (CRT) or the like. Similar to communication device 112, the communication device 114 has a processor 130, memory 132, and a display 134. In other embodiments, the communication devices 112, 114 can include other types of output device(s) instead of, or in addition to the displays 128, 134. For example, the communication devices 112, 114 can include an audio output device (e.g., a speaker), a tactile output device, an attached printer (wired and/or wireless) and/or the like.

In some embodiments, a web browser application can be stored in the memory 126 of the communication device 112. Using the web browser application, the communication device 112 can send data to and receive data from the host device 116. Similarly, the communication device 114 can include a web browser application. In such embodiments, the communication devices 112, 114 can act as thin clients. This allows minimal data to be stored on the communication devices 112, 114. In other embodiments, the communication devices 112, 114 can include one or more applications specific to communicating with the host device 116 during a retirement planning system process. In such embodiments, the communication devices 112, 114 can download the application(s) from the host device 116 prior to participating in the retirement income maximizing process.

As discussed above, the communication devices 112, 114 can send data to and receive data from the host device 116 associated with the retirement planning system. In some embodiments, the data sent between the communication devices 112, 114 and the host device 116 can be formatted using any suitable format. In some embodiments, for example, the data can be formatted using extensible markup language (XML), hypertext markup language (HTML) and/or the like.

In some embodiments, one or more portions (e.g., the processor 120) of the host device 116 and/or one or more portions (e.g., the processor 124, 130) of the communication devices 112, 114 can include a hardware-based module (e.g., a digital signal processor (DSP), a field programmable gate array (FPGA)) and/or a software-based module (e.g., a module of computer code 123 to be executed at a processor, a set of processor-readable instructions that can be executed at a processor). In some embodiments, one or more of the functions associated with the host device 116 (e.g., the functions associated with the processor 120) can be included in one or more such modules (see, e.g., FIG. 2). In some embodiments, one or more of the functions associated with the communication devices 112, 114 (e.g., functions associated with processor 124 or processor 130) can be included in one or more modules similar to the modules shown and described with respect to FIG. 2.

In some embodiments, one or more of the communication devices 112, 114 can be configured to perform one or more functions associated with the host device 116, and vice versa. For example, in some embodiments, at least a portion of the retirement planning system 100 can be executed at the communication device 112. In other embodiments, the entire retirement planning system 100 can be executed at/upon the communication device 112. In such an embodiment, for example, the processor 124 can execute instructions (code) associated with the retirement planning system stored locally to the communication device 112 in the memory 126. In such embodiments, the communication device 112 need not be in communication with the host device 116 to execute the retirement planning system. In still other embodiments, a host-device 116 and/or a network 118 is not required, as all the herein described software functions of the retirement planning system 100 could run on a stand-alone personal computer that has been specially-programmed to provide the hereinafter disclosed modules and functions. For example, the communication device 112 may be specially-programmed by the processor 124 executing the instructions (code) which implements the modules and functions disclosed herein, transforming the communication device 112 into a (handheld) optimal retirement plan calculator.

FIG. 2 is a schematic diagram of a host device 200 configured to perform a retirement planning system analysis for a user 210, according to an embodiment. The host device 200 can be structurally and functionally similar to the host device 116 shown and described with respect to FIG. 1. Although not shown in FIG. 2, the host device 200 can include a memory and a processor, which are similar to the memory 122 and the processor 120 shown and described with respect to FIG. 1.

As shown in FIG. 2, the host device 200 includes an input module 220, a profile agent module 222, a grid analyst module 224, a multi-variables calculation module 226, life plan module 228, a tax computation module 230, and a presentation module 232. Although not shown in FIG. 2, the modules can be stored in, for example, the memory within the host device 200 and executed by, for example, the processor of the host device 200. Each of the modules can be a hardware-based module (e.g., a DSP, a FPGA), a software-based module (e.g., a module of program code, such as code 123 to be executed at the processor, a set of processor-readable instructions that can be executed at the processor), or a combination of hardware and software modules.

In some embodiments, each module shown in FIG. 2 can be in direct communication with each other module. In other embodiments, each module need not be in direct communication with each other module. For example, in the illustrated embodiment of FIG. 2, the input module 220 is in direct communication with the profile agent module 222, and the profile agent module 222 is in direct communication with both the input module 220 and the grid analyst module 224, while the grid analyst module might not be in direct communication with the input module 220. In some embodiments, each module hosted in the host device 200 can be operatively coupled to each other module hosted in the host device 200.

The modules shown in FIG. 2 can function as a retirement planning system for a user, such as the user 210, which may be an individual and/or a spouse of the individual. That is, the modules can be configured to collectively perform a retirement planning system analysis for the user 210 if either an individual or a married couple. Additionally, the user 210 can be any person that can operate and/or interact with the host device 200. In some embodiments, the user 210 can be a representative of an individual or a married couple. For example, the user 210 can be a relative (e.g., child) of the individual or the individual or married couple, or a financial advisor hired by the individual or married couple.

In some embodiments, as described in detail herein, the user 210 can provide information to the host device 200, and receive and/or view a life plan generated by the host device 200 based on the provided information associated with the retirement goals of the individual or married couple. In some embodiments, the user 210 can interact with the host device 200 using a communication device similar to the communication device 112 or 114 shown and described with respect to FIG. 1. In some embodiments, the user 210 can enter the information associated with the individual or married couple to the retirement planning system 100 using, for example, a keypad, a touch screen, a mouse, or any other suitable input means. In some embodiments, the user 210 can receive or view the life plan for the individual or married couple using, for example, a monitor, a speaker, a printer, or any other suitable output means.

The input module 220 can be configured to receive input values from the user 210, via an electrical communications link 234 in FIG. 2, such as provided in one embodiment between the communication devices 112, 114 and host device 116 in FIG. 1, or via a keyboard, mouse, touch screen, and/or microphone associated with/provide by the input module 220. The input values received from the user 210 can include data regarding the individual or married couple. In some embodiments, the input values can include data and/or information associated with each individual from the individual or married couple, such as, for example, name, age, historical Social Security covered earnings, life expectancy, life expectancy adjustment (increase or decrease from a standard, predetermined life expectancy), etc. In some embodiments, the input values can include data and/or information associated with the individual or married couple, such as, for example, a monthly expected Social Security (SS) benefit at full retirement value, a SS benefit Cost of Living Adjustment (COLA) value, an anticipated monthly pension and/or annuity value, an anticipated monthly pension COLA and/or annuity COLA value, a total current savings value, an anticipated Rate of Return (ROR) in retirement value, a desired retirement age value, a total desired net monthly retirement income value, and/or an anticipated inflation rate value. The input module 220 can be operatively coupled to an information database 236, via communication link 238, and can be provided part of and/or networked to the host device 200. The information database 236 can be, for example, memory 122 or database 125 as depicted in FIG. 1, and programmed in response to an input request to output to the input module 220 each user's investment data records, current mortality tables, results from a life expectancy predicator based on the inputted at least one value received from the input module, and tax forms and tax tables for use by the tax builder module 230 as discussed in later sections provided herein.

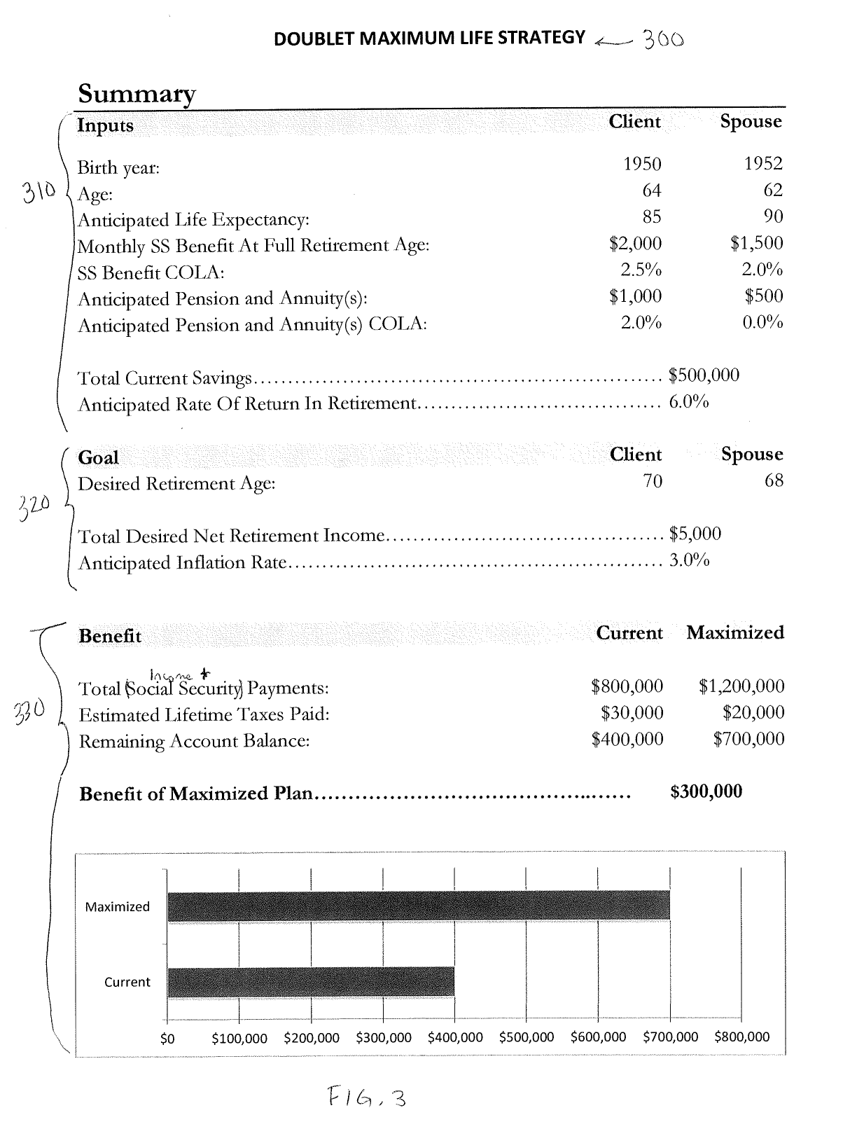

FIG. 3 illustrates assumptions, retirement goals and a projected benefit of a maximized life plan 300 for a married couple Client and Spouse, according to an embodiment. The section 310 illustrates the input values associated with the individual or married couple. As shown in the section 310 of FIG. 3, data and information associated with each individual from the married couple (i.e., Client and Spouse) can include, for example, at least name, date of birth, age, life expectancy, monthly SS benefit at full retirement age for each individual, SS benefit COLA, anticipated pension and annuity(s), anticipated and annuity(s) COLA, total current savings, and anticipated rate of return in retirement. Additionally, as shown in section 320, the input values associated with the retirement goals of each user is also shown, which can include a desired retirement age, a total desired net retirement income, and an anticipated inflation rate. In some embodiments, some of the above inputs can be dynamically filled in by the profile agent module 222 providing such suggested input values to the input module 220 which presents such suggested input values to the user 210. Furthermore, in some embodiments, more or less information than those items shown in the section 310 can be received from a married couple and used in the retirement planning system process for the individual or married couple. For example, in some embodiments, information associated with real assets (e.g., a home, a boat, a motor home, a plane, property, etc.) can be received. Based on the input values received from Client and/or Spouse, a retirement planning analysis can be performed for the individual or married couple Client and Spouse, which result in a summary section 330 which shows a current or projected value and a maximized value achieved by the resulting recommendations of the life plan, which is discussed in later sections herein.

Returning to FIG. 2, the profile agent module 222 can be operatively coupled to the input module 220, via electrical communication link 240, and configured to calculate a user profile 242 based on the input of at least one value. The profile agent module 222 can be operatively coupled to a dynamic profile database 244, via electrical communication link 246, and can in response to each inputted at least one value dynamically (i.e., automatically populate or fill in) provide to the input module 220 additional suggested and/or default inputs to the user 210. The user 210 can either accept or change such dynamically provided information when inputting such information to the input module 220. It is to be appreciated that the user profile 242 can be presented to the user 210 with missing information shown via a graphical user interface provided by or connected to the input module 220. Such dynamically suggested and/or default input values may comprise calculated current age, default life expectancy, and retirement age based on date of birth input, as well as a desired monthly retirement income, anticipated inflation rate, and ROR in retirement based on averages for similarly situated users of the same age, and received from dynamic profile database 244 in response to such a request from the profile agent module 222. The dynamic profile database 244 may be, for example, memory 122 and/or database 125 (FIG. 1).

Once the input of information is completed by the user 210, via an inputted completion acknowledgement from the user 210 to the input module 220, the user profile 242 is then created by the profile agent module 222 based on the inputted and/or dynamically filled information. The user profile 242 created, in some embodiments, will include the following information: a birth year/birth date value, an age value, an anticipated life expectancy value, a monthly expected Social Security (SS) benefit at full retirement value, a SS benefit Cost of Living Adjustment (COLA) value, an anticipated monthly pension and/or annuity value, an anticipated monthly pension COLA and/or annuity COLA value, a total current savings value, an anticipated Rate of Return (ROR) in retirement value, a desired retirement age value, a total desired net monthly retirement income value, and/or an anticipated inflation rate value.

The grid analyst module 224 can be operatively coupled to the profile agent module 222, via electrical communication link 248, to receive as input the created user profile 242 outputted from the profile agent module 222. The grid analyst module 224 uses the information provided in the user profile 242 to select automatically all applicable life and death variables 250 possible based on the values provided. Such life and death variables 250 can include all the possible changes and/or impacts on the desired retirement income due to, e.g., earlier or later retirement, which can range from taking retirement at each age of the user from a current age up to life expectancy age, the range of ages in which to elect SS benefits, changes in incomes and savings amounts due to early or delayed drawdown, death of a spouse, up and down changes in tax bracket, up and down changes in ROR in retirement, and/or up and down changes in the anticipated inflation rate value. The grid analyst module 224 can be operatively coupled to a life and death variables database 252, via electrical communication link 254, and can in response to receiving the user profile 242 from the profile agent module 222 automatically select from the database 252 all the applicable life and death variables 250. The life and death variables database 252 may be, for example, memory 122 and/or database 125 (FIG. 1).

The multi-variables calculation module 226 can be operatively coupled to the grid analyst module 224, via electrical communication link 256, to receive as input the life and death variables 250 outputted from the grid analyst module 224 based on the user profile(s) 242. The multi-variables calculation module 226 then uses the values provided in the user profile(s) 242 and each of the life and death variables to calculate all possible total retirement income outcomes from all possible retirement ages to the life expectancy age for the user(s), i.e., over the range of total retirement years. As part of each of the total retirement income outcome calculations, the multi-variables calculation module 226 uses the inputted values for total savings, total investments, expected ROR rate for savings and/or investments in retirement, pensions, annuities, COLAs for the pensions and/or annuities, the income value from any other income source, and the expected Social Security income to determine the total retirement income through the range of retirement years of the user(s). It is to be appreciated that the multi-variables calculation module 226 calculates each expected Social Security income for all the Social Security benefit election options available to the user(s) as part of the total retirement income outcome analysis. Additionally, as part of each of the total retirement income outcome calculations, the multi-variables calculation module 226 uses income tax tables as well as Adjusted Gross Income tax calculations to determine the total income tax impact through the range of retirement years of the user(s) based on each income source total for each year in the associated range of retirement years. The multi-variables calculation module 226 can be operatively coupled to a multi-variant scenarios database 258, via electrical communication link 260, and can in response to receiving the user profile 242 and the life and death variables 250 from the grid analyst module 224 automatically select from the database 258 all the applicable tax table values, and the Adjusted Gross Income and Social Security benefit election option computations that used the current Social Security tax and benefit rules in effect. The multi-variant scenarios database 258 may be, for example, memory 122 and/or database 125 (FIG. 1).

To better highlight the processes performed by the multi-variable calculation module automatically, the follow example is provided hereafter. Should in one case, Client and Spouse both desire to retire at age 60, the multi-variables calculation module 226 will calculate the total retirement income and estimated lifetime taxes paid from age 60 of both spouses to expected death of both based on the inputted values in the user profiles 242 and the selected life and death variables 250, as well as a remaining account balance at the end of latest life expectancy age of the spouses taking into account the inputted desired monthly retirement income adjusted annual by the inputted anticipated inflation rate (see section 320 of FIG. 3). The results of this calculation is outputted to the user 210 and listed as the calculated amounts provided adjacent the “Total Retirement Income Payments”, “Estimated Lifetime Taxes Paid”, and “Remaining Account Balance” under the “Current” column heading depicted in section 330 in FIG. 3. Additionally, the multi-variables calculation module 226 will perform the same calculations as previously, i.e., the total retirement income, estimated lifetime taxes paid, and remaining account balance from ages 61-70 of each spouse based on the inputted values in the user profiles 242, the selected life and death variables 250, and the expected Social Security income for each Social Security benefit election options available to each spouse. With each calculation iteration, the multi-variables calculation module 226 compare each iteration result with the previous iteration result and keeps the result based on retirement age (which may be different from the inputted desired retirement age of each spouse), the Social Security election option made (including any applicable reductions and/or credits if early or delayed claiming based on the retirement age) and tax filing status for each spouse which results in the largest remaining account balance based on total retirement income and accounting for estimated lifetime taxes paid, and the desired inputted monthly net retirement income (i.e., after taxes) adjusted yearly for inflation through retirement. The results of this retirement income maximizing calculation is outputted to the user 210 and listed as the calculated amounts provided adjacent the “Total Retirement Income Payments”, “Estimated Lifetime Taxes Paid”, and “Remaining Account Balance” under the “Maximized” column heading depicted in section 330 in FIG. 3. As also depicted in FIG. 3, the benefit of the result of the above maximizing calculation performed by the multi-variables calculation module 226 can be shown as resulting amount from subtracting the computed “Maximized” remaining account balance amount from the computed “Current” remaining account balance amount as well as a plot of such amounts to graphically show such a difference between such computed amounts.

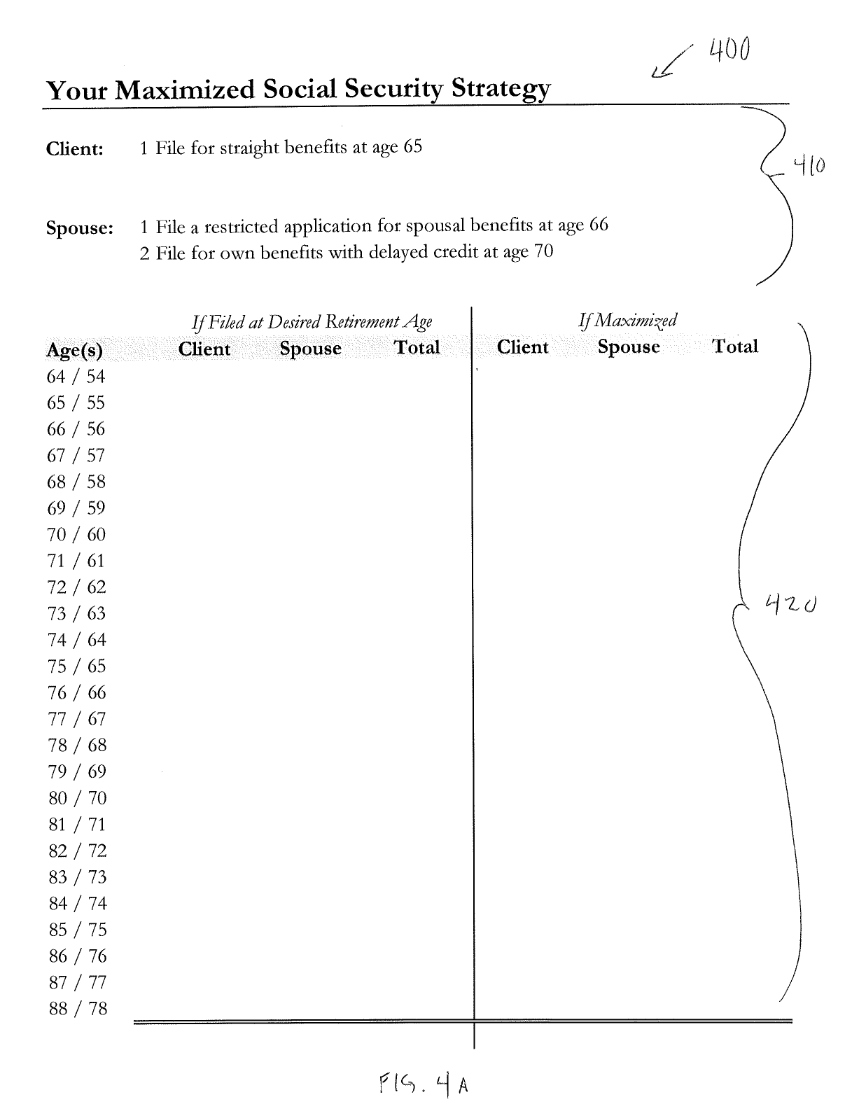

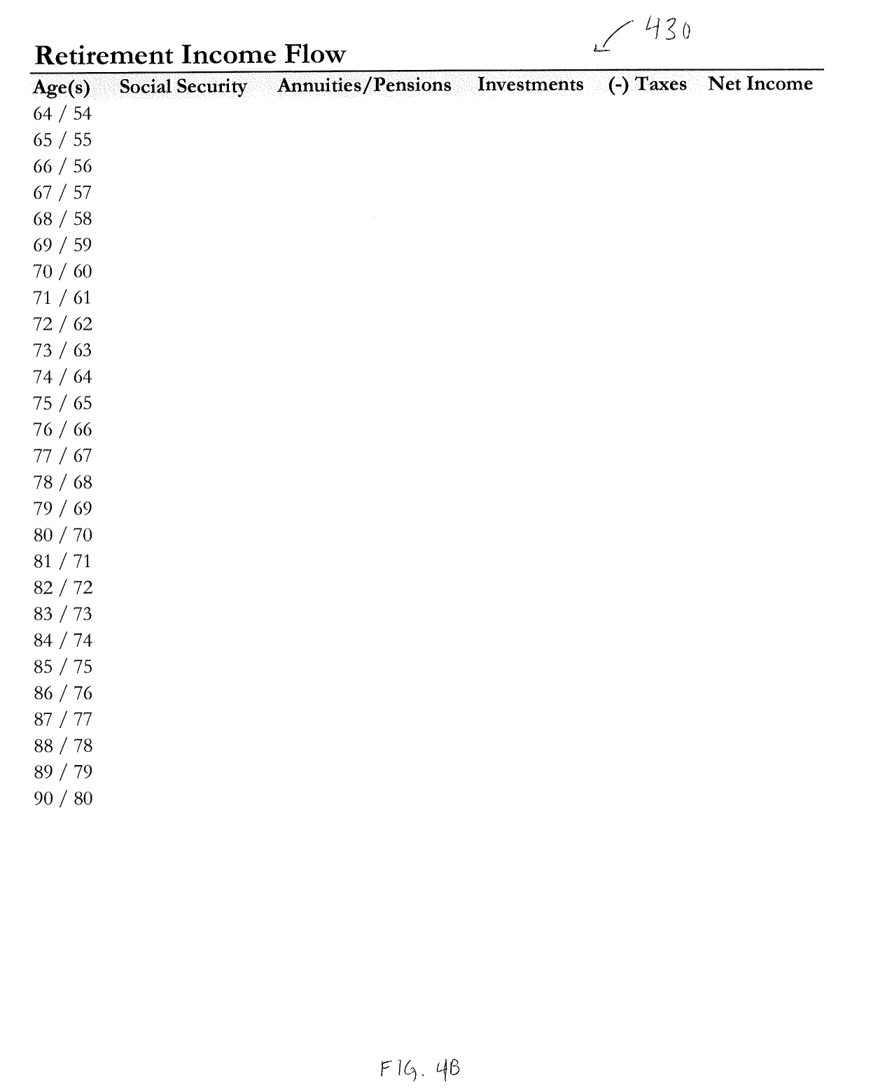

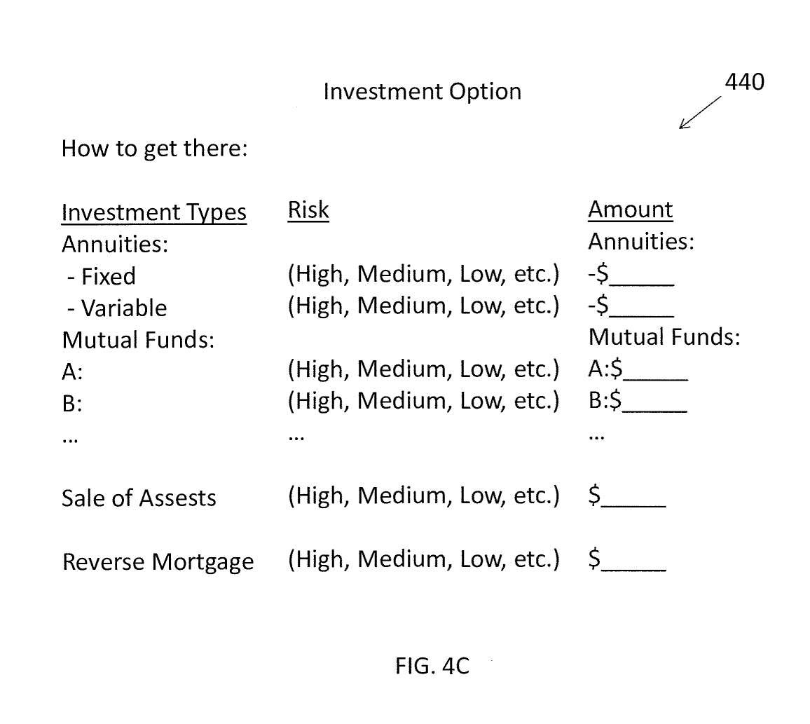

The full life planner module 228 can be operatively coupled to the multi-variables calculation module 226, via electrical communication link 262, to receive as input resulting data 264 outputted from the multi-variables calculation module 226 as well as the user profile(s) 242. The resulting data 264 comprises values from both the above described current and maximizing calculations as well as information regarding the benefit election option (at what age to take and what SS election option) and tax filing status selected which resulted in the maximizing calculations that provides the user(s) with a maximized total retirement income. The full life planner module 228 then determines a breakdown of the yearly Social Security income if filed at the inputted desired retirement age(s) versus according to the age(s), type of SS benefit election, and tax filing status as provided in the resulting data 264. This information is provided as a Maximized Social Security Strategy 400 that is outputted to the user as depicted by FIG. 4A, wherein the age and election option are provide in a section 410 and the yearly breakdown comparisons is provided in section 420. The full life planner module 228 then determines a breakdown of the yearly retirement income based on the other income sources provided in the user profile 242, e.g., annuities, pensions, investments, and a breakdown of the yearly impact of the Federal Income Tax in retirement to provide a yearly breakdown of the net income after taxes based on the Maximized Social Security Strategy 400. This information is provided as a Retirement Income Flow 430 that is outputted to the user as depicted by FIG. 4B, wherein a yearly net income for each retirement age is shown computed from the computed yearly values for Social Security income, annuities/pensions income, investments income, minus income taxes.

The full life planner module 228 can be operatively coupled to the tax builder module 230, such as via electrical communication link 266, to request that tax calculations and/or tax forms be generated by the tax builder module 230 based in the resulting data 264 outputted from the multi-variables calculation module 226 as well as the user profile(s) 242. As mentioned above in a previous section, the tax builder module 230 can be operatively coupled to the information database 236, such as via electrical communication link 266, to request and receive needed tax tables and/or tax forms based on the resulting data 264 and the user profile(s) 242. In some embodiments, the tax builder module 230 provides as output to the full life planner module 228 the yearly values for Social Security income and/or income taxes that are used in the Maximized Social Security Strategy 400, and the Retirement Income Flow 430. In addition, in some embodiments the tax builder module 230 can provide as output to the full life planner module 228 a tax data file 268 comprising completed tax forms for a current year based on the resulting data 264 and user profile(s) and/or the completed forms to make the SS election option which maximums total retirement income.

In the event that the inputted resulting data 264 indicates a retirement income shortfall, the full life planner module 228 can additionally provide an investment options report in which to make up the income shortfall. Such an Investment Option report 440 is depicted by FIG. 4C, and can include recommendations regarding types of investment options, e.g., rental property, mutual funds, annuities, sale of assets, reverse mortgages, etc., their associated risk, historical rate of returns, and amount need to make the computed retirement income shortfall in present dollars.

The result of the processing of the full life planner module 228 is a life plan 270 which can be outputted to a life build database 272 operatively connected, such as via electrical communication link 274, to the full life planner module 228. The life plan 270 comprises the Maximized Social Security Strategy 400, the Retirement Income Flow 430, the Investment Option report 440, the complete tax forms for the current year, and/or the completed forms for making the SS benefit election which maximizes the total retirement income of the user(s). The life build database 272 may be, for example, memory 122 and/or database 125 (FIG. 1).

The presentation module 232 can be operatively coupled to the life build database 272 to receive as input the created life plan 270 outputted from the full life planner module 228, such as via electrical communication link 276. It is be appreciated that the receiving of the life plan 270 by the presentation module 232 and the presentation by the presentation module 232 graphically to the user(s) on a communication device 112, 114 (FIG. 1) and/or on a graphical user interface of the input module 220, such as via electrical communication link 280 and/or 282, can be contemporaneously or in near real time (i.e., less than a few seconds) of completing and sending the input required to build the user profile(s) by the profile agent module 222 from the input module 220 by the user(s). This contemporaneously receipt of the life plan 270 by a user adds great utility and usefulness to the methods and apparatus for calculating an optimal retirement plan based on income needs, incomes sources and federal income tax impacts for individuals and married couples, as such calculations would otherwise take multiple experts and multiple hours, if not days, to complete. As time is valuable to both users planning for retirement as well as to retirement planners helping clients in their retirement goals, the embodiments of the present invention thus disclosed herein help to reduce the overall time commitment to develop such a life plan, which can quickly (i.e., less than a few seconds) show a user(s) the means in which to achieve their retirement goals, i.e., a realistic age of retirement and monthly income amount based on current income, savings, life expectancy, expected savings and income at retirement, and which takes into account an optimized Social Security benefit election, expected rate of return, expected inflation, and the Federal Income Tax impact in retirement. In other words, the contemporaneous receipt and presentation by the presentation module 232 of the life plan 270, after the inputting of information into the input module 220 according to the present invention by a user(s), adds great utility and usefulness as it permits a user(s) to know quickly (i.e., less than a few seconds) an answer to the question of “what do I (we) need to do now to make sure I (we) do not outlive our retirement income?” The contemporaneous receipt and presentation of the life plan 270 by the presentation module 232 according to the present invention permits such a user(s) to run quickly through multiple what-if scenarios and decide on a life plan 270 which presents the most realistic options to meets their retirement goals. Additionally, for example, determining such a life plan 270 is likely impossible without the use of a special purpose apparatus, such as the host device 200, as the computations based only on all of the age combinations for a married couple at a retirement age of 61 can result in having to compute and compare well over 1000 different mathematical calculations.

In some embodiments, the life plan 270 presented by the presentation module 232 provides the SS benefit election option that should by selected by each user (individual and/or spouse) and timing of such selection, as well as a comparison of the resulting yearly income at each age of retirement for each user (individual and/or spouse) if taking a normal election at retirement and if taking the suggested SS benefit election to make the most of retirement income. The life plan 270 may also present the yearly retirement, after tax net income flow broken out by each portion contributed by Social Security, Annuities/Pensions, and Investments as well as the portion reduced by taxes. The life plan 270 may also present other suggested options such as annuities, mutual funds, sale of assets, and/or reverse mortgages, if the yearly retirement, after tax net income is insufficient to meet the inputted desired monthly retirement income of the user(s). The life plan 270 may also present a suggestion to reduce the inputted desired monthly retirement income of the user(s) to a suggested amount, if none of the above suggested options are possible. In some embodiments, the presentation module 232 can be presented to the user 210 the information from the life plan 270 as depicted by FIGS. 3, 4A, 4B and 4C or in some other suitable form, such as, for example, a report, a graph, a table, a selectable user-interface, or the like.

Although each module shown in FIG. 2 is included in the host device 200, in some other embodiments, some of the modules can be hosted at a communication device (e.g., the communication devices 112, 114 in FIG. 1) or some other device operatively coupled to the host device 200. For example, the input module 220 and the presentation module 232 can be hosted at the communication device. In such an example, the communication device 112, 114 can receive input values from the user 210, and then send the received values to the host device 200. The communication device 112, 114 can also receive the life plan 270 from the host device 200 for presenting to the user 210. For another example, the calculation modules (e.g., profile agent module 222, the grid analyst module 224, the multi-variables calculation module 226, the full life planner module 228, and/or the tax builder module 230) can be hosted at a server device operatively coupled to the host device 200. In this example, the calculations can be performed at the server device, and the input data and results can be transmitted between the server device and the host device 200.

In some embodiments, one or more of communication devices (e.g., the communication devices 112, 114 shown in FIG. 1) can be configured to perform one or more functions associated with the host device 200. For example, in some embodiments, at least a portion of the retirement planning system 100 can be executed at a communication device operatively coupled to the host device 200. In some other embodiments, the entire retirement planning system 100 can be executed at such a communication device. In such embodiments, a processor (e.g., the processor 124, 130 in FIG. 1) of the communication device 112, 114 can execute instructions associated with the retirement planning system 100 stored local to the communication device in a memory (e.g., memory 126, 132) of the communication device. In such embodiments, the communication device need not be in communication with the host device 200 to execute the retirement planning system 100.

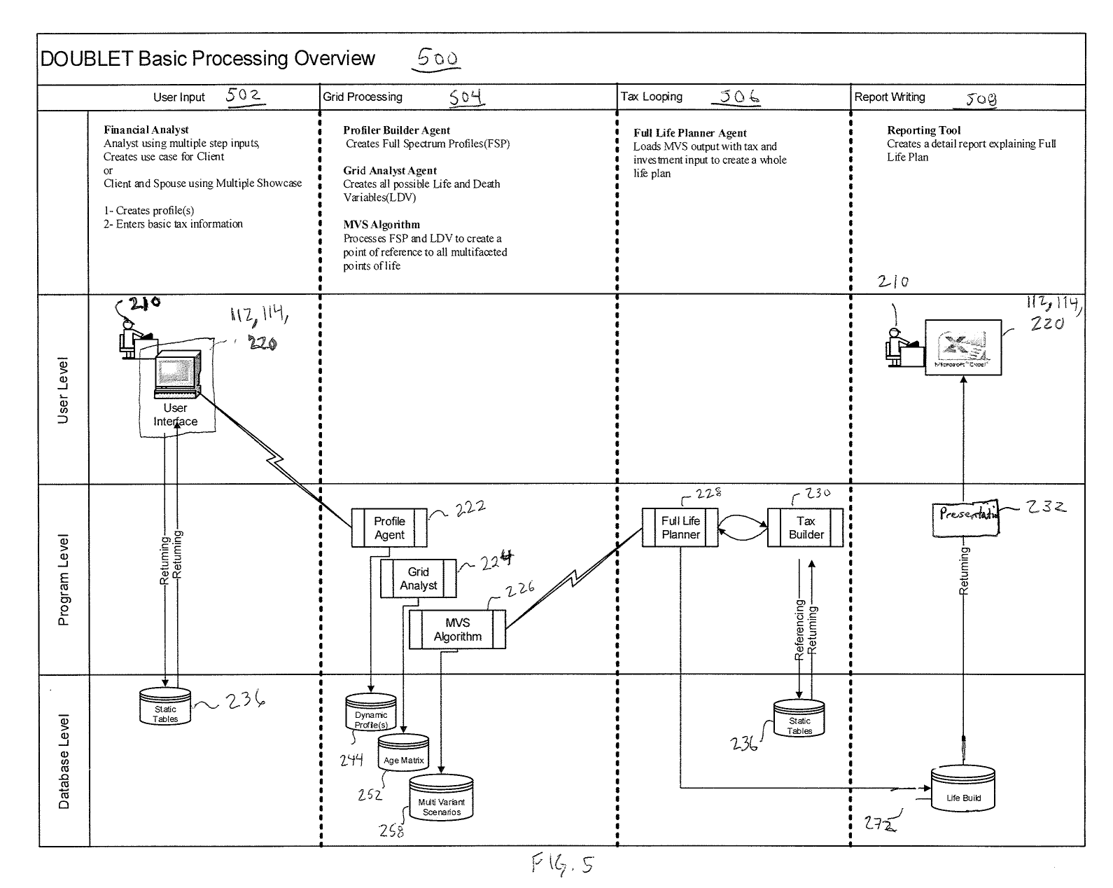

FIG. 5 is a flow chart illustrating a method 500 of performing a retirement planning system analysis, according to an embodiment. Such a method can be performed by a processor of a host device (e.g., the processor 120 of the host device 116 in FIG. 1) or a processor of a communication device (e.g., the processor 124 of the communication device 112 in FIG. 1). For example, a host device can have a non-transitory processor-readable medium, such as memory 122, which can store code 123 representing instructions to be executed by the processor of the host device. The stored code 123 can comprise program code to cause the processor to perform the following operations.

At step 502, an input value can be received from a user at the host device. As previously discussed above in the example of FIG. 2, the input module 220 within the host device 200 can be configured to receive one or more input values from the user 210 as illustrated, for example, in section 310 of FIG. 3, which in part can be based on information received from the information database 236. At step 504, a grid processing step is conducted in which the profile agent module 222 creates a user profile, such as user profile 242 (FIG. 2), based on the inputted values and/or values received from the dynamic profile database 244, the grid analyst module 224 uses the user profile to select applicable life and death variables from the life and death variables database 252, and the multi-variables calculation module 226 uses the user profile and the selected application life and death variables to determine result data, such as resulting data 264, which provides values from both the current and maximizing calculations as well as information regarding the benefit election option (at what age to take and what SS election option) and tax filing status selected which resulted in the maximizing calculations that provides the user(s) with a maximized total retirement income, as previously described above in reference to FIG. 2. It is to be appreciated that during step 504, the resulting data is calculated from finding from all the available election strategies from the set of election strategies for each available age combination associated with that election strategy for the individual or married couple, each election strategy's effects of income tax in retirement and investment values adjusted for an inputted rate of return in retirement, a result which maximizes the retirement income of the user(s).

In step 506, a tax loop process is conducted in which the full life planner module 228 then determines a breakdown of the yearly Social Security income if filed at the inputted desired retirement age(s) versus according to the age(s), type of SS benefit election, and tax filing status, such as provided in the resulting data 264 (FIG. 2). During this tax loop process, the full life planner module 228 can request the tax builder module 230 perform and provide tax calculations and/or generate and provide completed tax forms based in the resulting data 264 outputted from the multi-variables calculation module 226 as well as the user profile(s) 242. As mentioned above in a previous section, the tax builder module 230 can be operatively coupled to the information database 236, to request and receive needed tax tables and/or tax forms based on the resulting data 264 and the user profile(s) 242. In some embodiments, the tax builder module 230 provides as output to the full life planner module 228 the yearly values for Social Security income and/or income taxes that are used in the Maximized Social Security Strategy 400, and the Retirement Income Flow 430. In addition, in some embodiments the tax builder module 230 can provide as output to the full life planner module 228 a tax data file 268 comprising completed tax forms for a current year based on the resulting data 264 and user profile(s) and/or the completed forms to make the SS election option which maximums total retirement income.

In the event that the inputted resulting data 264 indicates a retirement income shortfall, the full life planner module 228 can additionally provide an investment options report in which to make up the income shortfall. Such an Investment Option report 440 is depicted by FIG. 4C, and can include recommendations regarding types of investment options, e.g., rental property, mutual funds, annuities, sale of assets, reverse mortgages, etc., their associated risk, historical rate of returns, and amount need to make the computed retirement income shortfall in present dollars.

The result of the processing of the full life planner module 228 and the tax builder module 230 in the tax looping step 506 is a life plan, such a life plan 270, which is outputted to the life build database 272 in a report writing step 508. As discussed above in a previous section, the life plan 270 comprises the Maximized Social Security Strategy 400, the Retirement Income Flow 430, the Investment Option report 440, the complete tax forms for the current year, and/or the completed forms for making the SS benefit election which maximizes the total net retirement income of the user(s). Additionally, in this report writing step 508, the presentation module 232 receives as input the created life plan 270 which can be presented to the user 210, via communication device 112, 114 and/or input module 220 as well as printed as a hard copy report.

Some embodiments described herein relate to a computer storage product with a non-transitory computer-readable medium (also can be referred to as a non-transitory processor-readable medium) having instructions or computer code thereon for performing various computer-implemented operations disclosed herein. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Additionally, the invention can be part of a computer program that can be down loaded through the (worldwide web) internet and/or used as part of a subscriber based financial planning service.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

What is claimed is:

1. A non-transitory processor-readable medium storing code representing instructions to be executed by a processor, said instructions which when executed cause the processor to:
receive as input financial information which comprises desired retirement age, retirement income requirements, available income sources and investment risk tolerance of a user;
create a user profile from the financial information received;
calculate, using the user profile, a suggested strategy which balances the income requirement impacted by taxes to the available income sources and accounting for the investment risk tolerance of the user;
calculate, using the user profile, a set of all possible life and death variables;
create a life plan using the set of all possible life and death variables and user profile; and
present as output on a display the life plan which comprises an optimal retirement plan based on inputted desired retirement age, income requirements, inputted available incomes sources, and income tax impacts to the user.

2. An optimal retirement plan calculating apparatus for a user comprising:
a display,
a processor, and
memory storing code which when executed by the processor causes the processor to:
receive as input financial information which comprises desired retirement age, retirement income requirements, available income sources and investment risk tolerance of a user;
create a user profile from the financial information received;
calculate, using the user profile, a suggested strategy which balances the income requirement impacted by taxes to the available income sources and accounting for the investment risk tolerance of the user;
calculate, using the user profile, a set of all possible life and death variables;
create a life plan using the set of all possible life and death variables and user profile; and
present as output on the display the life plan which comprises an optimal retirement plan based on inputted desired retirement age, income requirements, inputted available incomes sources, and income tax impacts to the user.

3. A retirement planning system for a user comprising:
a host device with a processor and memory storing code which when executed causes the processor to implement an input module, a profile agent module, a grid analyst module, a multi-variables calculation module, a full-life planner module and a tax builder module, wherein the host device:
receives via the input module one or more input values related to a desired retirement age, income needs and incomes sources of the user;
creates automatically via the profile agent module a user profile based on the one or more input values received;
selects automatically via the grid analyst module applicable life and death variables from a life and death variables database based on the user profile created;
determines automatically via the multi-variables calculation module result data based on the user profile created and the application life and death variables selected, the result data comprises values for a current total retirement income and a maximized total retirement income, and information regarding benefit election option and tax filing status selected which resulted in the maximized total retirement income determined by the multi-variable calculation module;
determines automatically via the full life planner module which runs a tax loop process, a life plan which comprises a breakdown of yearly Social Security income if filed at the inputted desired retirement age versus according to an age, type of SS benefit election, and tax filing status as provided in the resulting data, wherein in the tax loop process, the full life planner module automatically requests the tax builder module perform and provide tax calculations and/or generate and provide completed tax forms based in the resulting data outputted from the multi-variables calculation module as well as the user profile; and
provides the life plan as output from the full life planner module and the tax builder module that results from the tax loop process.

4. The retirement planning system of claim 3, wherein the life plan is outputted to a life build database.

5. The retirement planning system of claim 3, wherein the life plan is outputted to a display and/or a printer.

6. The retirement planning system of claim 3, wherein the life plan comprises information providing a Maximized Social Security Strategy, a Retirement Income Flow, an Investment Option report, complete tax forms for current year, and/or completed forms for making a SS benefit election which maximizes the total net retirement income of the user.

7. The retirement planning system of claim 3, wherein the one or more input values is inputted by the user on the host device or based on information received from an information database via a network.

8. The retirement planning system of claim 3, wherein the benefit election option comprises information regarding at what age the user should elect to receive social security benefits and what social security election option should be made by the user.

9. The retirement planning system of claim 3, wherein the resulting data is determined by the multi-variable calculation module finding from all available election strategies from a set of election strategies for each available age combination associated with that election strategy for an individual or married couple, each election strategy's effects of income tax in retirement and investment values adjusted for an inputted rate of return in retirement, a result which maximizes retirement income of the user.

10. The retirement planning system of claim 3, wherein the tax builder module is operatively coupled to an information database to request and receive needed tax tables and/or tax forms based on the resulting data and the user profile.

11. The retirement planning system of claim 3, wherein the tax builder module provides as output to the full life planner module the yearly values for Social Security income and/or income taxes that are used in the Maximized Social Security Strategy, and the Retirement Income Flow.

12. The retirement planning system of claim 3, wherein the tax builder module provides as output to the full life planner module a tax data file comprising completed tax forms for a current year based on the resulting data and user profile(s) and/or the completed forms to make the SS election option which maximums total retirement income.

13. The retirement planning system of claim 3, wherein, if the resulting data indicates a retirement income shortfall, the full life planner module provides an investment options report in which to make up the income shortfall.

14. The retirement planning system of claim 13, wherein the investment options report includes recommendations regarding types of investment options, their associated risk, historical rate of returns, and amount need to make the computed retirement income shortfall in present dollars.

15. The retirement planning system of claim 14, wherein the type of investment options comprises one or more of rental property, mutual funds, annuities or other suitable investment assets, sale of assets, and reverse mortgages.

16. A computer-implemented retirement planning method that creates a life plan which shows and explains an optimal retirement plan based on inputted desired retirement age, inputted income needs, inputted incomes sources, and income tax impacts to a user, said method comprising:
executing via a processor code which implements on a host device an input module, a profile agent module, a grid analyst module, a multi-variables calculation module, a full-life planner module and a tax builder module;
receiving via the input module one or more input values related to the desired retirement age, income needs and the incomes sources of the user;
creating automatically via the profile agent module a user profile based on the one or more input values received;
selecting automatically via the grid analyst module applicable life and death variables from a life and death variables database based on the user profile created;
determining automatically via the multi-variables calculation module result data based on the user profile created and the application life and death variables selected, the result data providing values for a current total retirement income and a maximized total retirement income, and information regarding benefit election option and tax filing status selected which resulted in the maximized total retirement income determined by the multi-variable calculation module;
determining automatically via the full life planner module running a tax loop process, a life plan which comprises a breakdown of yearly Social Security income if filed at the inputted desired retirement age(s) versus according to the age(s), type of SS benefit election, and tax filing status as provided in the resulting data, wherein during the tax loop process, the full life planner module automatically requests the tax builder module perform and provide tax calculations and/or generate and provide completed tax forms based in the resulting data outputted from the multi-variables calculation module as well as the user profile; and
providing the life plan as output from the full life planner module and the tax builder module resulting from the tax loop process.

17. The computer-implemented retirement planning method of claim 16, wherein providing the life plan as output from the full life planner module and the tax builder module resulting from the tax loop process is outputting to one or more of a life build database, a display and a printer.

18. The computer-implemented retirement planning method of claim 16, wherein the life plan comprises information providing a Maximized Social Security Strategy, a Retirement Income Flow, an Investment Option report, complete tax forms for current year, and/or completed forms for making a SS benefit election which maximizes the total net retirement income of the user.

19. The computer-implemented retirement planning method of claim 16, wherein the one or more input values is inputted by the user on a host device or based on information received from an information database via a network.

20. The computer-implemented retirement planning method of claim 16, wherein the benefit election option comprises information regarding at what age the user should elect to receive social security benefits and what social security election option should be made by the user.

21. The computer-implemented retirement planning method of claim 16, wherein the resulting data is determined by the multi-variable calculation module finding from all available election strategies from a set of election strategies for each available age combination associated with that election strategy for an individual or married couple, each election strategy's effects of income tax in retirement and investment values adjusted for an inputted rate of return in retirement, a result which maximizes retirement income of the user.

22. The computer-implemented retirement planning method of claim 16, wherein the tax builder module is operatively coupled to an information database to request and receive needed tax tables and/or tax forms based on the resulting data and the user profile.

23. The computer-implemented retirement planning method of claim 16, wherein the tax builder module is providing as output to the full life planner module the yearly values for Social Security income and/or income taxes that are used in the Maximized Social Security Strategy, and the Retirement Income Flow.

24. The computer-implemented retirement planning method of claim 16, wherein the tax builder module is providing as output to the full life planner module a tax data file comprising completed tax forms for a current year based on the resulting data and user profile(s) and/or the completed forms to make the SS election option which maximums total retirement income.

25. The computer-implemented retirement planning method of claim 16, wherein, if the resulting data indicates a retirement income shortfall, the method further comprises the full life planner module providing an investment options report in which to make up the income shortfall.

26. The computer-implemented retirement planning method of claim 25, wherein the investment options report includes recommendations regarding types of investment options, their associated risk, historical rate of returns, and amount need to make the computed retirement income shortfall in present dollars.

27. The computer-implemented retirement planning method of claim 26, wherein the type of investment options comprises one or more of rental property, mutual funds, annuities or other suitable investment assets, sale of assets, and reverse mortgages.
